(19) United States
(12) Patent Application Publication
(10) Pub. No.: US 2006/0093098 A1
(43) Pub. Date: May 4, 2006

(54) System and method for communicating instant messages from one type to another

(75) Inventor: Liang-Chern Tarn, Taipei (TW)

Correspondence Address: WILSON SONSINI GOODRICH & ROSATI, 650 PAGE MILL ROAD, PALO ALTO, CA, 94304-1050, US

(73) Assignee: Xcome Technology Co., Ltd., Taipei (TW)

(21) Appl. No.: 11/082,409

(22) Filed: Mar. 17, 2005

(30) Foreign Application Priority Data
Oct. 28, 2004 (TW) 093132811

(51) Int. Cl. H04M 11/00; H04M 1/64

(52) U.S. Cl. 379/88.14; 379/88.01

(57) ABSTRACT

A system and method are disclosed for communicating messages from one type to another. The system includes an instant message communication module, a speech recognition module, a speech-processing module, a voice-processing module and a dictionary module. The method includes a step of inputting data, a step of transforming the data from one type to another, and a step of sending the transformed data. Through the system and method, a user can communicate with a counterpart who inputs a different type of messages.

### BACKGROUND OF THE INVENTION

1. Field of the Invention

The present invention relates to a messenger for communicating instant messages and, more particularly, to a system and method for communicating instant messages from one type to another.

2. Description of the Related Art

As network communication technology develops rapidly, various instant messengers for use on the Internet and mobile communication networks are prospering. Through these instant messengers, communication between people is not limited because of space and time. In any place, at any time, by using a desktop, notebook, palmtop computer, or even a mobile phone through the Internet (wireless or cable) and/or the mobile communication networks (high power or lower power), a user can connect with more than one counterpart. That is, through these instant messengers, using various systems and techniques based on the Internet or the mobile communication networks such as wireless local area networks (WLAN), general packet radio service (GPRS), code division multiple access (CDMA) or any other communication systems and techniques of the third generation, a user can communicate with others while stationary or moving.

At present, instant messengers can sends text, real-time voice, files and real-time video. However, it is operated in a simple mode. That is, the messages are sent and received in only one format. For example, if a user sends a text message, a counterpart will receive a text message. If, a user sends a real-time voice message, a counterpart will receive a real-time voice message. This simple mode limits the flexibility of use. For example, if a user is driving, he will not be able to watch a display or conduct the input of text. Hence, he or she cannot read and reply to a text message from a counterpart. If a user does not have a speaker or earphone and a microphone, he will not be able to listen and reply to a voice message from a counterpart.

### SUMMARY OF INVENTION

The primary objective of the present invention is to eliminate the problems encountered in the conventional messengers; that messages cannot be transformed from one type to another because of the simple mode in which they are operated.

To achieve the foregoing objective, the present invention provides a system and method for communicating messages from one type to another. The system includes an instant message conversation module, a speech recognition module, a language-processing module, a speech-processing module and a dictionary-correcting module. The method includes a step of inputting data, a step of transforming the data from one type to another, and a step of sending the transformed data.

The present invention can transfer messages from one type to another to let users communicate among each other with different types of messages, which enhances the flexibility of use for the communicating the instant messaging system.

Other objects, advantages and novel features of the invention will become more apparent from the following detailed description in conjunction with the attached drawings.

### BRIEF DESCRIPTION OF DRAWINGS

FIG. 1 is a block diagram of a system for communicating instant messages from one type to another according to the present invention.

FIG. 2A is a flow chart of a method for transforming text data to voice data by means of the system shown in FIG. 1.

FIG. 2B is a flow chart of a first aspect of the method shown in FIG. 2A.

FIG. 2C is a flow chart of a second aspect of the method shown in FIG. 2A.

FIG. 3A is a flow chart of a method for transforming voice data to text data by means of the system shown in FIG. 1.

FIG. 3B is a flow chart of a first aspect of the method shown in FIG. 3A.

FIG. 3C is a flow chart of a second aspect of the method shown in FIG. 3A.

### DETAILED DESCRIPTION OF EMBODIMENTS

A system for communicating instant messages from one type to another according to the present invention can be used in an electronic device such as a computer and a mobile phone connected to a network such as the Internet and the mobile communication networks.

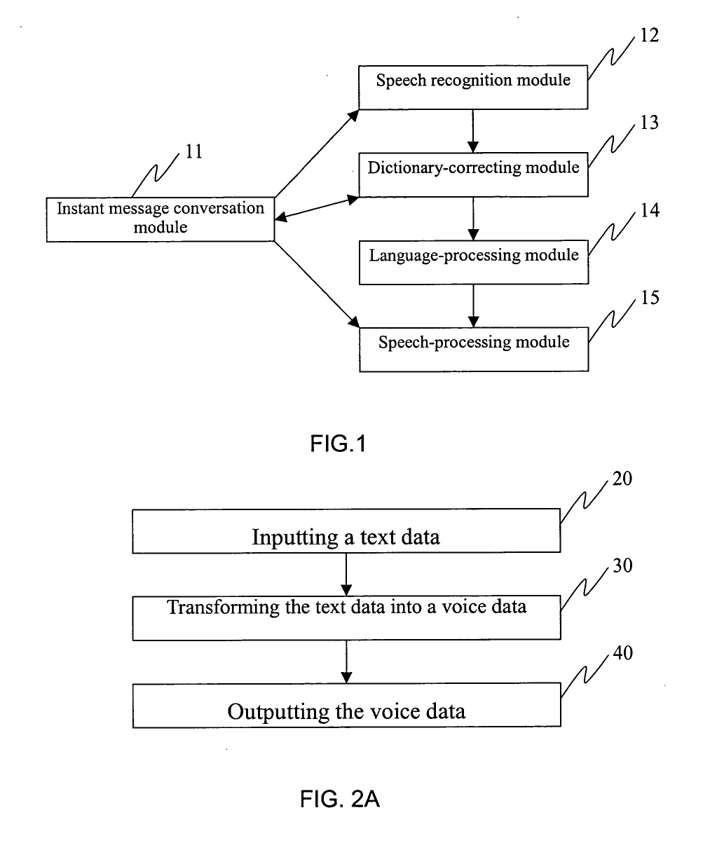

Referring to FIG. 1, a block diagram of the system according to the present invention, the system includes an instant message conversation module 11, a speech recognition module 12, a language-processing module 14 and a speech-processing module 15.

The instant message conversation module 11 is used to initiate a message communication in order to connect a user with a counterpart. In communication, the instant message communication module 11 handles the input and output of instant messages such as receiving instant messages from a counterpart and sending instant messages to the counterpart. A user can input instant messages to the instant message communication module 11 through an input device such as a keyboard and a microphone. The instant message communication module 11 can present instant messages to a user through an output device such as a display and a speaker. The instant message communication module 11 can of course terminate an instant message communication.

The speech recognition module 12 is used to recognize and transform a speech data into a text data.

The language-processing module 14 uses a natural language processing technique to transform a text data into a speech data. The speech data includes phoneme data and prosody data.

The speech-processing module 15 is used to transform a speech data into a voice data. In detail, the phoneme data and the prosody data are filtered, compared and analyzed in a voice segment database in order to generate a corresponding voice data.

To obtain a correctly transformed message, the system may include a dictionary-correcting module 13 for transforming the text data into a correct text data. In detail, the text data is compared in a dictionary database in order to generate a correct text data.

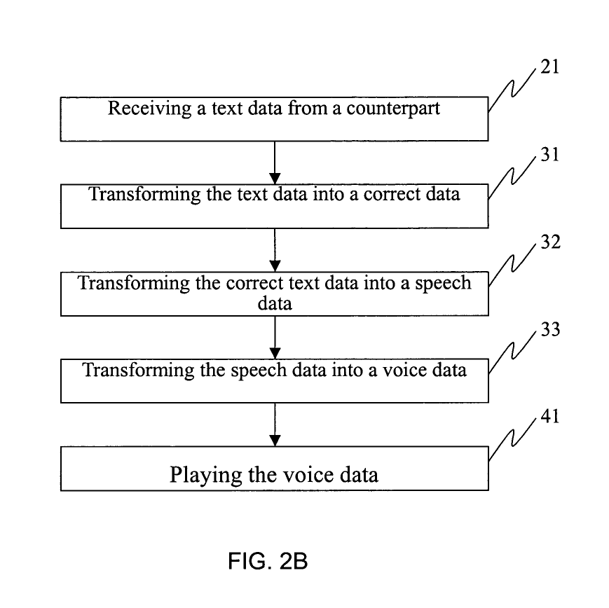

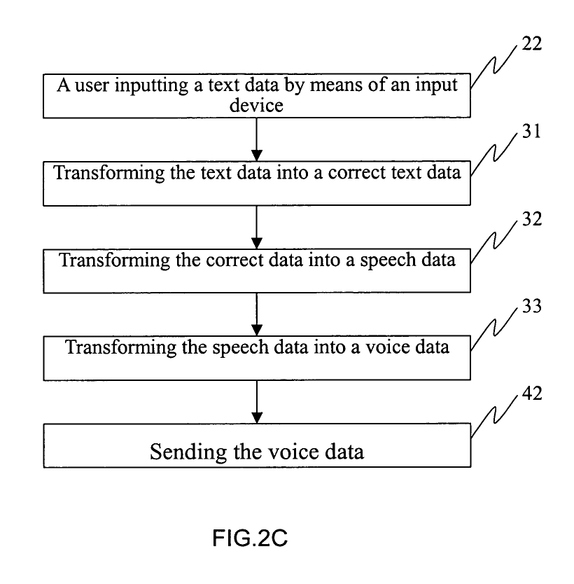

FIG. 2A is a flow chart of a method for transforming text data to voice data by means of the system shown in FIG. 1. The method includes a step of inputting a text data (Step 20), a step of transforming the text data into a voice data (Step 30), and a step of outputting the voice data (Step 40).

FIG. 2B is a flow chart of a first aspect of the method shown in FIG. 2A for use in a situation that a user has a microphone while a counterpart does not have a speaker and would like to send a text data to the user. In this situation, the user has to transform the text data into a voice data.

Step 20 includes Step 21 of receiving the text data from the counterpart through the instant message conversation module 11.

Step 30 includes Steps 31 through 33. At Step 31, the text data is transformed into a correct text data by means of the dictionary-correcting module 13. Step 31 can however be omitted. At Step 32, the correct text data is transformed into a speech data by means of the speech-processing module 14. The speech data includes phoneme data and prosody data. At Step 33, the speech data is transformed into a voice data by means of the speech-processing module 15.

Step 40 includes Step 41. At Step 41, the voice data is played by means of an earphone.

FIG. 2C is a flow chart of a second aspect of the method shown in FIG. 2A for use in a situation that a user does not have a microphone and would like to send a text data to a counterpart who only has a speaker. In this situation, the user has to transform the text data into a voice data.

Step 20 includes Step 22 at which the user inputs the text data to the instant message communication module 11 by means of a keyboard.

Step 30 includes Steps 31 through 33. At Step 31, the text data is transformed into a correct text data by means of the dictionary-correcting module 13. Step 31 can however be omitted. At Step 32, the correct text data is transformed into a speech data by means of the speech-processing module 14. The speech data includes phoneme data and prosody data. At Step 33, the speech data is transformed into a voice data.

Step 40 includes Step 42. At Step 42, the voice data is sent to the counterpart by means of the instant message communication module 11.

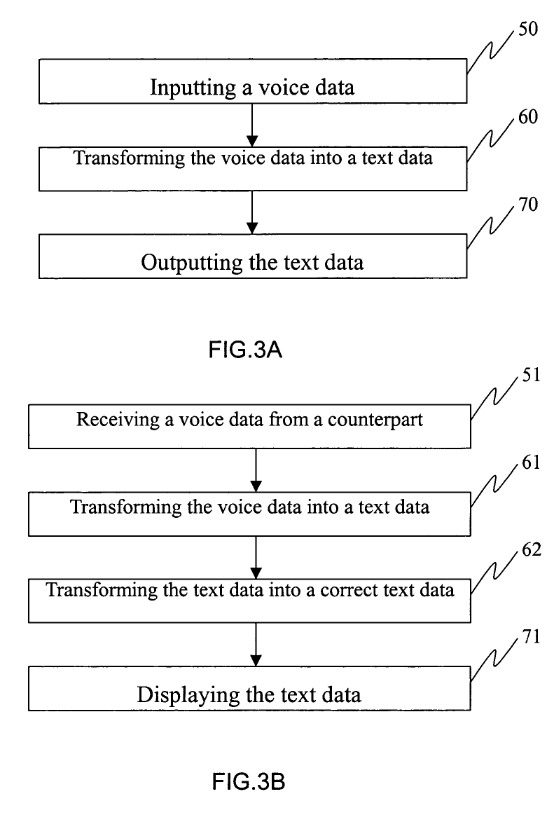

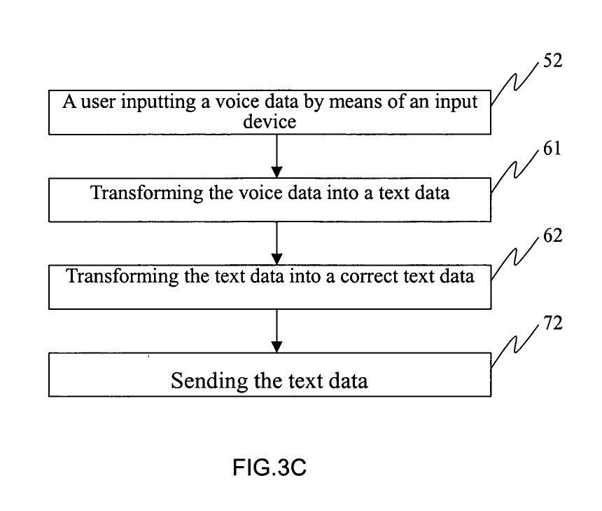

FIG. 3A is a flow chart of a method for transforming voice data to text data by means of the system shown in FIG. 1. The method includes a step of inputting a voice data (Step 50), a step of transforming the voice data into a text data (Step 60), and a step of outputting the text data (Step 70).

FIG. 3B is a flow chart of a first aspect of the method shown in FIG. 5A for use in a situation that a user does not have a speaker while a counterpart has a microphone and would like to send a voice data to the user. In this situation, the user has to transform the voice data into a text data.

Step 50 includes Step 51. At Step 51, the voice data is received from the counterpart through the instant message communication module 11.

Step 60 includes Steps 61 and 62. At Step 61, the voice data is transformed into a text data by means of the speech recognition module 12. At Step 62, the text data is transformed into a correct text data by means of the dictionary-correcting module 13. Step 62 can however be omitted.

Step 70 includes Step 71. At Step 71, the correct text data is sent to a display from the instant message communication module 11. The correct text data is displayed by means of the display.

FIG. 3C is a flow chart of a second aspect of the method shown in FIG. 3A for use in a situation that a user has a microphone and would like to send a voice data to a counterpart who does not have a speaker. In this situation, the user has to transform the voice data into a text data.

Step 50 includes Step 52 at which the user inputs the voice data to the instant message communication module 11 by means of a microphone.

Step 60 includes Steps 61 and 62. At Step 61, the voice data is transformed into a text data by means of the speech recognition module 12. At Step 62, the text data is transformed into a correct text data by means of the dictionary-correcting module 13. Step 62 can however be omitted.

Step 70 includes Step 72. At Step 72, the correct text data is sent to the counterpart by means of the instant message communication module 11.

As discussed above, by means of the system and method for communicating instant messages from one type into another, a user can communicate with a counterpart who inputs a different type of messages.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A system for communicating a message from one type into another, said system comprising:
an instant message conversation module for initiating and terminating an instant message communication through a network and for processing the input and output of an instant message during the instant message communication;
a speech recognition module for transforming a voice data into a text data;
a language-processing module for transforming a text data into a speech data; and
a speech-processing module for transforming a speech data into a voice data.

2. The system as claimed in claim 1 wherein said instant message conversation module receives and sends said instant message through said network.

3. The system as claimed in claim 1 wherein said instant message conversation module can display said instant message through a display.

4. The system as claimed in claim 1 wherein said instant message conversation module receives said instant message from an input device.

5. The system as claimed in claim 1 wherein said speech data includes phoneme data and prosody data.

6. The system as claimed in claim 1 wherein said speech-processing module compares said speech data in a database in order to generate said voice data.

7. The system as claimed in claim 1 comprising a dictionary-correcting module for transforming said text data into a correct text data.

8. The system as claimed in claim 7 wherein said dictionary-correcting module compares said text data with a dictionary database in order to generate said correct text data.

9. A method for use in a system for communicating an instant message from one type into another, said method comprising the steps of:
inputting a text data;
transforming said text data into a voice data; and
outputting said voice data.

10. The method as claimed in claim 9 wherein said step of transforming said text data into a voice data further comprises the steps of:
transforming said text data into a speech data; and
transforming said speech data into said voice data.

11. The method as claimed in claim 9 comprises a step of correcting said text data.

12. The method as claimed in claim 9 wherein said step of inputting a text data comprises a step of said system receiving a text data from a counterpart.

13. The method as claimed in claim 9 wherein said step of sending said voice data comprises a step of playing said voice data through a voice-generating device.

14. The method as claimed in claim 9 wherein said step of inputting a text data comprises a step of a user inputting a text data to said system through an input device.

15. The method as claimed in claim 9 wherein said step of sending said voice data comprises a step of sending said voice data to a counterpart.

16. A method for use in a system for communicating an instant message from one type into another, said method comprising the steps of:
inputting a voice data;
transforming said voice data into a text data; and
outputting said text data.

17. The method as claimed in claim 16 wherein said step of transforming said voice data into a text data comprises a step of transforming said voice data into a text data by means of a speech recognition technique.

18. The method as claimed in claim 16 comprising a step of correcting said text data.

19. The method as claimed in claim 16 wherein said step of inputting a voice data comprises a step of said system receiving a voice data from a counterpart.

20. The method as claimed in claim 16 wherein said step of sending said text data comprises a step of displaying said text data through a display.

21. The method as claimed in claim 16 wherein said step of inputting a voice data comprises a step of a user inputting a voice data to said system through an input device.

22. The method as claimed in claim 16 wherein said step of sending said text data comprises a step of outputting said text data to a counterpart.
